(19) United States
(12) Patent Application Publication
(10) Pub. No.: US 2016/0323937 A1
(43) Pub. Date: Nov. 3, 2016

(54) HOB APPARATUS

(71) Applicant: BSH HAUSGERÄTE GMBH, München (DE)

(72) Inventors: Daniel Anton Falcon, Zaragoza (ES); Ignacio Garde Aranda, Zaragoza (ES); Oscar Gracia Campos, Zaragoza (ES); Ignacio Millan Serrano, Zaragoza (ES); Daniel Palacios Tomas, Zaragoza (ES); Oscar Pallares Zaera, Zaragoza (ES)

(21) Appl. No.: 15/105,688

(22) PCT Filed: Jun. 17, 2014
(86) PCT No.: PCT/IB2014/067014

§ 371 Date: Jun. 17, 2016

(30) Foreign Application Priority Data
Dec. 20, 2013 (ES) P201331877

(51) Int. Cl. H05B 6/06; H05B 6/04

(52) U.S. Cl. CPC H05B 6/065; H05B 6/04

(57) ABSTRACT

A hob apparatus includes a configuration unit having at least two input connections for connection to at least two inverters in one-to-one correspondence, at least two output connections for connection to at least two heating elements in one-to-one correspondence, and at least one switch operably connected to a first one of the at least two input connections and operably connected to at least a first one of the at least two output connections. The configuration unit operates the at least two inverters in at least one operating state in parallel to at least one of the at least two heating elements. The configuration unit includes at least one bridging element to connect the first one of the at least two input connections and a second one of the at least two output connections to one another independently of a switching position of the at least one switch.

The invention proceeds from a hob apparatus as claimed in the precharacterizing clause of claim 1.

A hob apparatus which comprises a configuration unit and is designed as an induction hob apparatus is already known from the prior art. The configuration unit has two input connections which are each intended to form a connection to at least one heating frequency unit. Furthermore the configuration unit has two output connections which are each intended to form a connection to a plurality of heating elements. In each case a switch of the configuration unit is disposed between a first of the input connections and a first of the output connections as well as between a second of the input connections and a second of the output connections. The switches are intended to switch the two heating frequency units in parallel.

The object of the invention consists in particular in providing a generic apparatus having improved properties in respect of high efficiency. The object is achieved by the features of claim 1, while advantageous embodiments and developments of the invention can be taken from the subclaims.

The invention proceeds from a hob apparatus, in particular an induction hob apparatus, having at least one configuration unit which has at least two input connections which are each intended to form a connection to at least one inverter, at least two output connections which are each intended to form a connection to at least one heating element, and at least one switch which is connected to a first input connection of the at least two input connections and at least to a first output connection of the at least two output connections, and which is intended to operate the at least two inverters in at least one operating state, in particular in at least one boost mode, in parallel to at least one of the at least two heating elements.

It is proposed that the at least one configuration unit has at least one bridging element which is intended to connect the first input connection and a second output connection of the at least two output connections to one another independently of a switching position of the at least one switch. A “hob apparatus” should be understood in particular to mean at least one part, in particular a subassembly, of a hob, in particular of an induction hob. In particular the hob apparatus can also comprise the entire hob, in particular the entire induction hob. A “configuration unit” should be understood in particular to mean a unit which is intended to assume different switching positions in at least two operating states different from one another. The at least one configuration unit has in particular at least one control contact which is advantageously intended to receive control signals generated in particular by a control unit and via which in particular in at least one operating state a switching position of the at least one configuration unit can be changed. An “inverter” should be understood in particular to mean an electrical unit which generates an oscillating electrical signal, preferably having a frequency of at least 1 kHz, in particular of at least 10 kHz, advantageously of at least 20 kHz and in particular of a maximum of 100 kHz for at least one heating element. In particular the inverter is intended to provide a maximum electrical output, required by the at least one heating element, of at least 100 W, in particular at least 500 W, advantageously at least 1000 W and preferably at least 1500 W. In this case the hob apparatus comprises in particular the at least two inverters. The phrase stating that a first object “is intended to form a connection to a second object” should be understood in particular to mean that in at least one operating state an electrically conductive connection exists between the first object and the second object, advantageously independently of at least one switching unit in the in particular electrically conductive connection, which in particular is disposed between the first object and the second object. A “heating element” should be understood in particular to mean an element which is intended in at least one operating state for an in particular inductive heating of a cooking container, in particular having a maximum heat output of at least 100 W, in particular of at least 500 W, preferably of at least 1000 W and particularly advantageously of at least 1500 W. In this case the hob apparatus comprises in particular the at least two heating elements, wherein the hob apparatus advantageously has a total of at least four, in particular at least six, advantageously at least eight and particularly advantageously a plurality of heating elements. A “switch” should be understood in particular to mean an element which is intended to establish and/or break an electrically conductive connection between at least two points, in particular contacts of the switch. In this case the switch is designed in particular as an electrical element and preferably has at least one control contact for receipt of a control signal, wherein the switch can be actuated via the control contact and in particular can be switched between the at least two contacts, in particular as a function of a control signal generated by a control unit. The phrase stating that a first object is “connected” to a second object should be understood in particular to mean that at least one operating state exists in which the first object and the second object are in contact with one another by means of an electrically conductive connection, wherein in particular in the at least one operating state electrical current flows between the first object and the second object via the electrically conductive connection. The phrase stating that the at least one configuration unit is intended to operate the at least two inverters in at least one operating state “in parallel to at least one of the at least two heating elements” should be understood in particular to mean that the at least one configuration unit is intended, in the at least one operating state, to connect the at least two inverters, in particular by changing a switching position of the at least one switch, simultaneously to the at least one heating element, and in particular to transfer energy generated by the at least two inverters simultaneously to the at least one heating element, in particular in order to achieve a high and advantageously higher output power of the at least one heating element. In this case the configuration unit comprises in particular an electrical connection between the second input connection and the first output connection, which in particular can be electrically switched. A “bridging element” should be understood in particular to mean an electrically conductive element which is intended to connect at least two contact points in particular directly electrically conductively to one another at least in an assembled state, in particular independently of an operating state and advantageously independently of switching positions of any switching units and/or of any switches. Different embodiments of the at least one bridging element which appear as expedient to a person skilled in the art are conceivable. For example, the at least one bridging element can be designed as a permanent connection between the at least two contact points, wherein the at least one bridging element in particular could be disposed fixedly on at least one circuit board. Likewise conceivable is that the at least one bridging element can be designed to be removable, wherein the at least one bridging element in particular enables different topologies and/or arrangements on the at least one circuit board. “Intended” should be understood in particular to mean specifically programmed, designed and/or configured. The statement that an object is intended for a specific function should be understood in particular to mean that the object fulfills and/or performs this particular function in at least one application state and/or operating state.

Thanks to the inventive embodiment it is possible in particular to achieve a high degree of efficiency, advantageously a high degree of electrical and/or in particular a high degree of economic efficiency. A high output power can advantageously be achieved, in particular since the at least one configuration unit is intended for high electrical currents. Because of the at least one bridging element a small electrical current through the switch can advantageously be achieved, as a result of which in particular a switch with low requirements and/or with a small size can be used. As a result, low costs can preferably be achieved.

The at least one switch could for example be connected exclusively to the first output connection, wherein exactly one electrical connection could exist between the first input connection and the second output connection, which in particular would be formed by the at least one bridging element. Preferably the at least one switch is however additionally connected to the second output connection, wherein in particular a “normally closed” contact of the at least one switch is connected to the second output connection. Alternatively it is conceivable for a “normally opened” contact of the at least one switch to be connected to the second output connection. This means that in particular a high degree of flexibility can be achieved.

For example the at least one bridging element could be intended to bridge the “normally opened” contact of the at least one switch.

Preferably the at least one bridging element is however intended to bridge a “normally closed” contact of the at least one switch, as a result of which in particular a high output power and/or a high current intensity can be provided at the second output connection.

It is further proposed that the at least one configuration unit has at least one second switch, which is connected to a second input connection of the at least two input connections and at least to the second output connection, as a result of which in particular a high degree of flexibility can be achieved.

For example, the at least one second switch could be connected exclusively to the second output connection, wherein advantageously exactly the one in particular switchable electrical connection could exist between the second input connection and the first output connection. Preferably the at least one second switch is however additionally connected to the first output connection, wherein the at least one second switch could form the one in particular switchable electrical connection. Various connection options of the at least one second switch to the first output connection are conceivable which appear expedient to a person skilled in the art. For example, a “normally opened” contact of the at least one switch could be connected to the first output connection. Advantageously however a “normally closed” contact of the at least one switch is connected to the first output connection. As a result further switches can in particular be dispensed with, as a result of which low costs can advantageously be achieved.

Furthermore it is proposed that the at least one configuration unit has at least one second bridging element which is intended to connect a second input connection of the at least two input connections and the first output connection to one another, as a result of which in particular a high degree of electrical and/or economic efficiency can be achieved.

If the at least one second bridging element is intended to bridge a “normally closed” contact of the at least one second switch, a component with low requirements can in particular be used for the at least one second switch, as a result of which low costs and/or a hob apparatus which can be acquired inexpensively by a customer can be achieved.

Furthermore it is proposed that the hob apparatus comprises a switching unit which is switched between the at least one configuration unit and the at least two heating elements. A “switching unit” should be understood in particular to mean an electronic unit which is intended to establish and/or break an electrically conductive connection at least between two contact points. The switching unit preferably has at least one control contact, via which the switching unit advantageously can be switched in at least one operating state and via which the switching unit receives in particular in at least one operating state at least one control signal, which advantageously is generated by a control unit. The phrase stating that the switching unit is switched “between” the at least one configuration unit and the at least two heating elements should be understood in particular to mean that in each operating state in which the at least two heating elements are fed with electrical current by the configuration unit the electrical current flows through the switching unit. When viewed in the direction of a cable path the switching unit is advantageously switched starting from the configuration unit upstream of the at least two heating elements. As a result in particular a high degree of flexibility can be achieved.

For example, the switching unit could have exactly one further switch which in particular could be intended—advantageously in the case of an incorrect switching position of the configuration unit—to break the connection between the at least one configuration unit and the at least two heating elements and in particular to perform an emergency switch-off. However, the switching unit preferably has at least two further switches which are each intended to connect one of the at least two heating elements individually to the configuration unit, wherein a number of further switches and a number of heating elements is advantageously at least substantially identical. As a result in particular a high degree of operational safety can be achieved.

Further advantages emerge from the following description of the drawing. Exemplary embodiments of the invention are illustrated in the drawing. The drawing, the description and the claims contain numerous features in combination. The person skilled in the art will expediently also consider the features individually and combine them to form meaningful further combinations.

In the drawing:

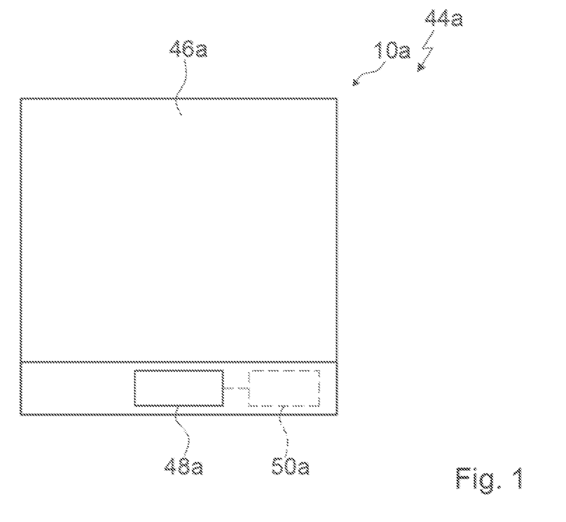

FIG. 1 shows an inventive hob having an inventive hob apparatus in a schematic planar view,

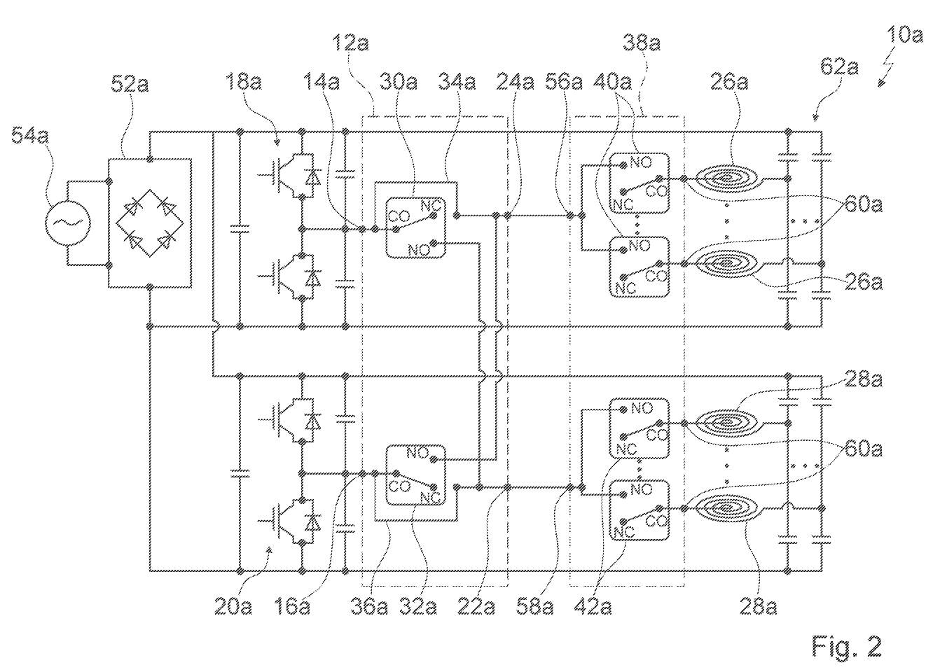

FIG. 2 shows the hob apparatus of the hob in a schematic illustration,

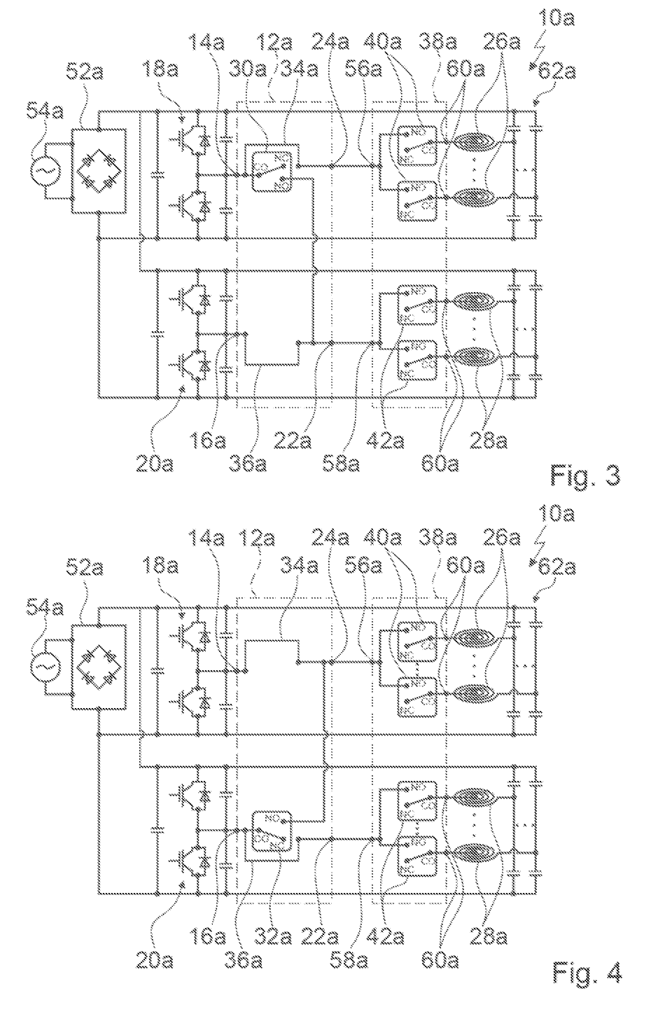

FIG. 3 shows a modified hob apparatus in a schematic illustration,

FIG. 4 shows a further modified hob apparatus in a schematic illustration,

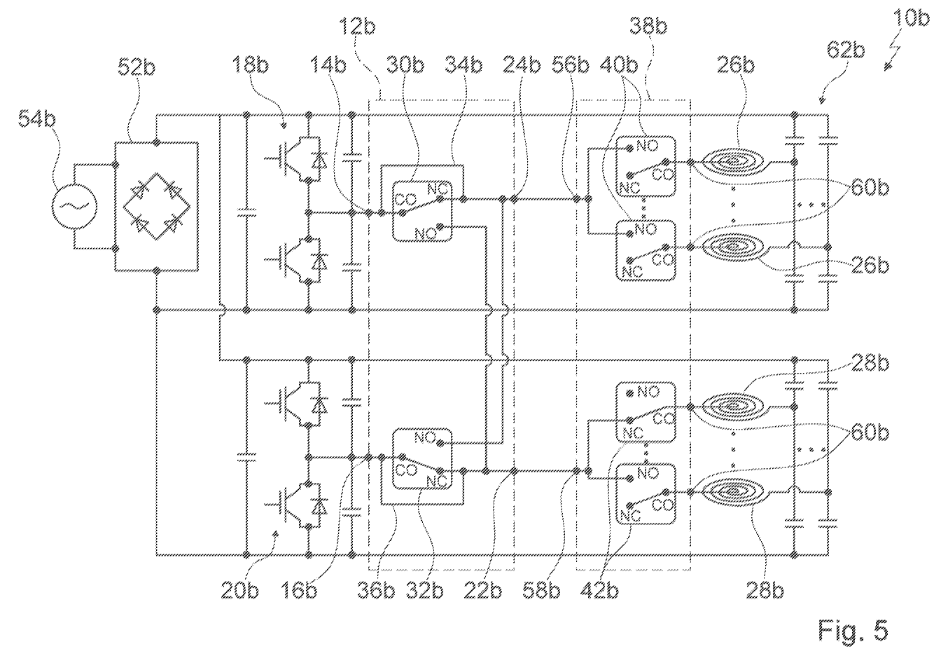

FIG. 5 shows an alternative hob apparatus in a schematic illustration,

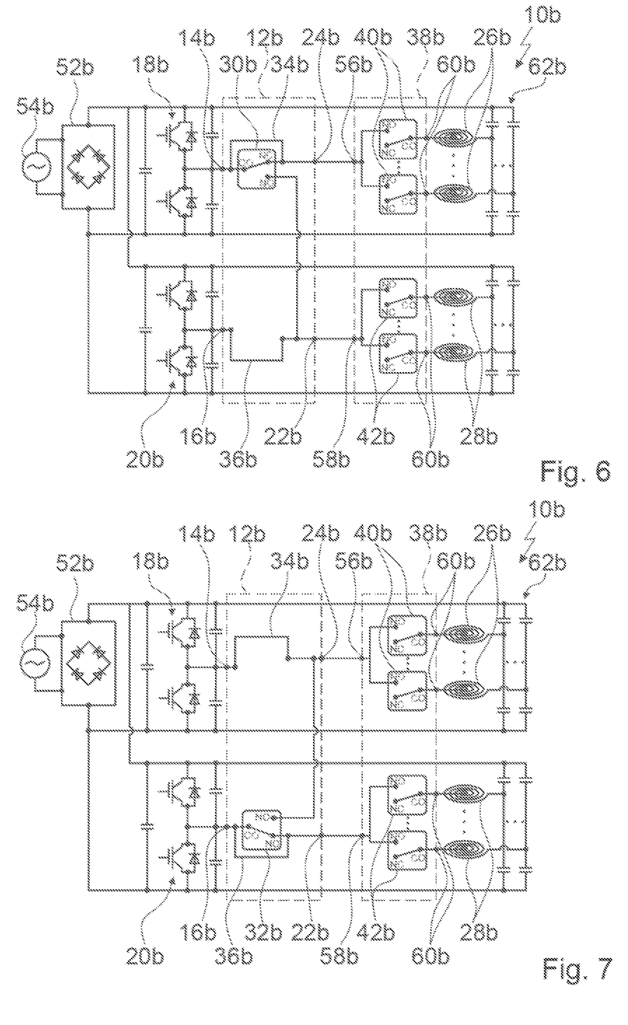

FIG. 6 shows a modified hob apparatus in a schematic illustration,

FIG. 7 shows a further modified hob apparatus in a schematic illustration,

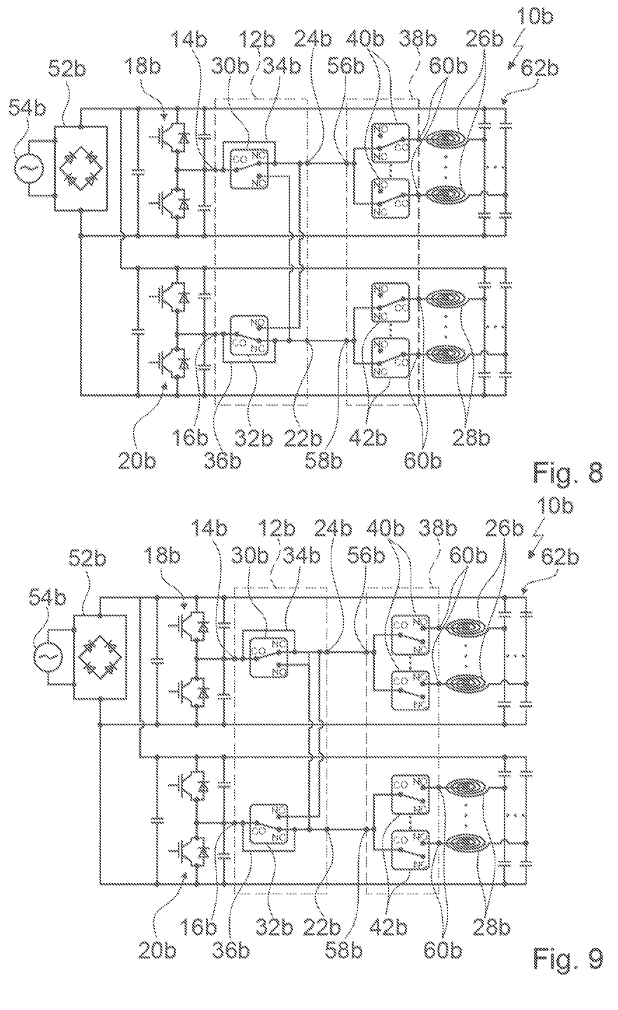

FIG. 8 shows a further modified hob apparatus in a schematic illustration,

FIG. 9 shows an alternative modified hob apparatus in a schematic illustration,

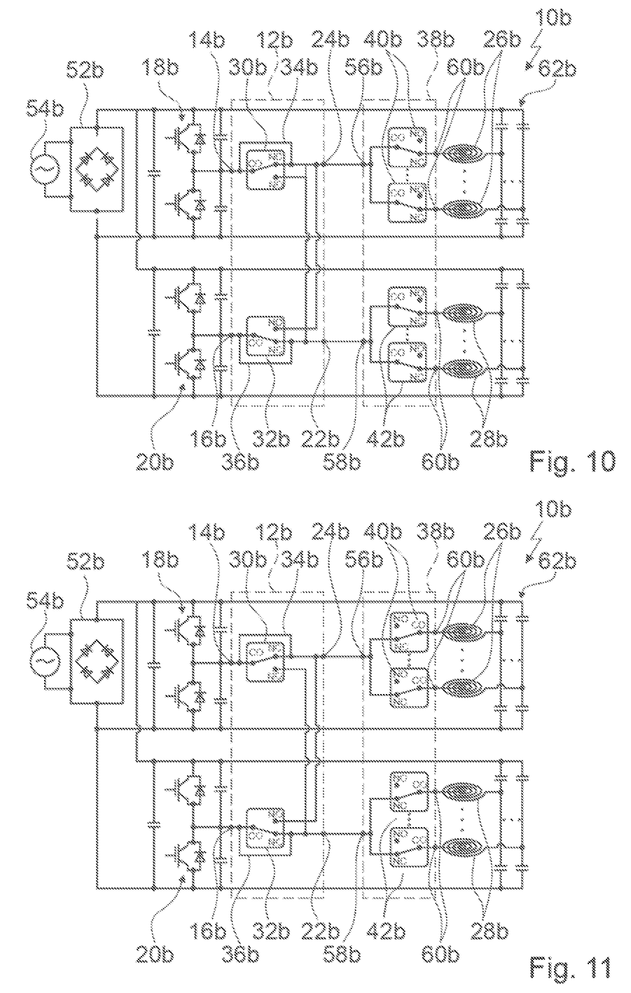

FIG. 10 shows a further alternative modified hob apparatus in a schematic illustration,

FIG. 11 shows a further alternative hob apparatus in a schematic illustration,

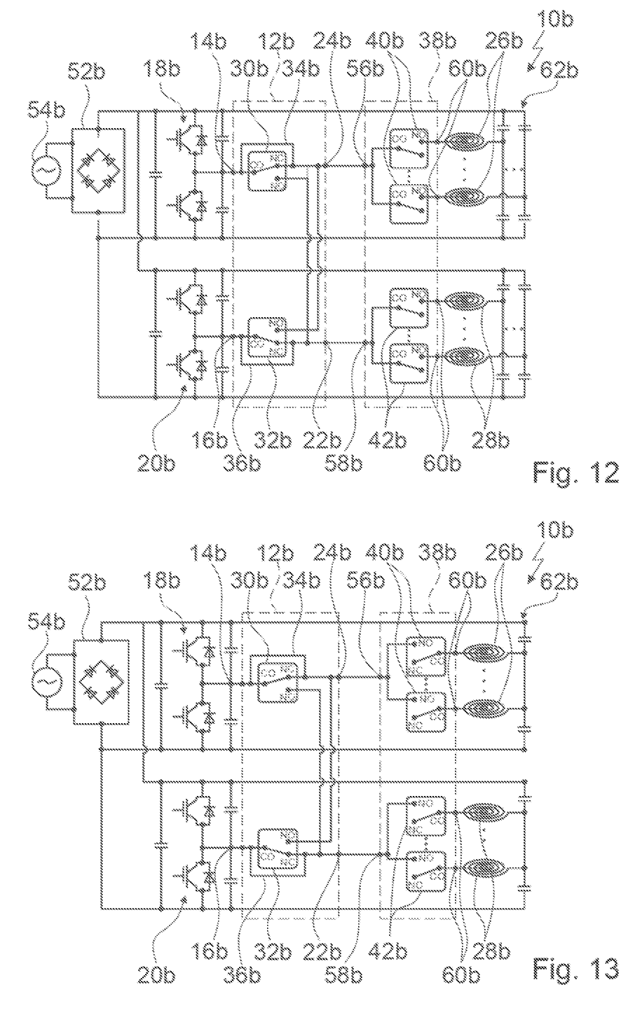

FIG. 12 shows a further modified hob apparatus in a schematic illustration and

FIG. 13 shows an alternative modified hob apparatus in a schematic illustration.

FIG. 1 shows a hob 44a, which is designed as an induction hob, having a hob apparatus 10a which is designed as an induction hob apparatus. The hob apparatus 10a has a hob plate 46a on which to place cooking containers. Furthermore the hob apparatus 10a comprises a plurality of heating elements 26a, 28a for heating cooking containers placed thereon (cf. FIG. 2). The heating elements 26a, 28a are designed as induction heating elements. In a built-in position the heating elements 26a, 28a are disposed underneath the hob plate 46a. In an assembled state the heating elements 26a, 28a are disposed in the form of a hob matrix. The heating elements 26a, 28a are disposed in a half-bridge circuit in the assembled state. The heating elements 26a, 28a are split into two groups. In this case a first group comprises the heating elements 26a and a second group comprises the heating elements 28a. Alternatively to a hob matrix it is conceivable for the heating elements to be designed as movably mounted heating elements which are intended to be moved underneath the hob plate in directions aligned substantially parallel to the hob plate. Furthermore it is conceivable for the heating elements to form a traditional hob, in which each heating element in particular defines an autonomous, separate heating zone which is advantageously marked on the hob plate.

The hob apparatus 10a comprises an operating unit 48a for inputting and/or selecting operating parameters, for example a heat output and/or a heat output density and/or a heating zone (cf. FIG. 1). The operating unit 48a is intended for the output of a value of an operating parameter to an operator. The hob apparatus 10a comprises a control unit 50a, which as a function of operating parameters input by means of the operating unit 48a performs actions and/or changes settings. In one operating state the control unit 50a operates the heating elements 26a, 28a as a function of operating parameters input by means of the operating unit 48a.

The hob apparatus 10a comprises a rectifier 52a, which is intended for connection to a phase Ma of a domestic power supply (cf. FIG. 2). Furthermore the hob apparatus 10a comprises two inverters 18a, 20a, which are each connected to the rectifier 52a. The inverters 18a, 20a are intended for generating a high-frequency alternating current. By means of the high-frequency alternating current generated by the inverters 18a, 20a the heating elements 26a, 28a are supplied in the operating state. As a function of the operating parameters input by means of the operating unit 48a the control unit 50a actuates the inverters 18a, 20a.

The inverters 18a, 20a are designed to be substantially identical, which is why in this section only one of the inverters 18a, 20a is considered. The inverter 18a has two series-connected, bidirectional unipolar switches. The switches are formed by a transistor and a parallel-switched diode. Furthermore the inverter 18a has in each case a damping capacitor switched in parallel to the bidirectional unipolar switches. A voltage tap of the inverter 18a is disposed at a shared contact point of two bidirectional unipolar switches.

The hob apparatus 10a comprises a configuration unit 12a which is switched between the inverters 18a, 20a and the heating elements 26a, 28a. The configuration unit 12a has two input connections 14a, 16a, which are each intended to form a connection to one of the inverters 18a, 20a. A first input connection 14a of the input connections 14a, 16a is connected to a first inverter 18a of the inverters 18a, 20a. A second input connection 16a of the input connections 14a, 16a is connected to a second inverter 20a of the inverters 18a, 20a. The configuration unit 12a has two output connections 22a, 24a. A first output connection 22a of the output connections 22a, 24a is intended to form a connection to the heating elements 26a. A second output connection 22a of the output connections 22a, 24a is intended to form a connection to the heating elements 28a.

The configuration unit 12a has a switch 30a and a second switch 32a. Alternatively to an embodiment of the configuration unit having two switches, an embodiment having exactly one switch is conceivable (cf. FIGS. 3 and 4). The switches 30a, 32a are designed as changeover switches (cf. FIG. 2). The switches 30a, 32a are designed as relays. The switch 30a is connected to the first input connection 14a and the first output connection 22a. The switch 30a has a “changeover” contact. The “changeover” contact of the switch 30a is connected to the first input connection 14a. The switch 30a has a “normally opened” contact and a “normally closed” contact. The “normally opened” contact of the switch 30a is connected to the first output connection 22a. The “normally opened” contact of the switch 30a is connected to the first output connection 22a. A “normally closed” contact of the switch 30a is free-standing, in particular connectionless. The second switch 32a is connected to the second input connection 16a and the second output connection 24a. The second switch 32a has a “changeover” contact. The “changeover” contact of the second switch 32a is connected to the second input connection 16a. The second switch 32a has a “normally opened” contact and a “normally closed” contact. The “normally opened” contact of the second switch 32a is connected to the second output connection 24a. The “normally closed” contact of the second switch 32a is free-standing, in particular connectionless.

The configuration unit 12a has a bridging element 34a and a second bridging element 36a. The bridging element 34a connects the first input connection 14a and the second output connection 24a to one another independently of a switching position of the switches 30a, 32a. Independently of a switching position of the switches 30a, 32a the configuration unit 12a has an electrically conductive connection between the first inverter 18a and the second output connection 24a. The electrically conductive connection between the first inverter 18a and the second output connection 24a is formed by the first bridging element 34a. The second bridging element 36a connects the second input connection 16a and the first output connection 22a to one another independently of a switching position of the switches 30a, 32a. The configuration unit 12a has an electrically conductive connection between the second inverter 20a and the first output connection 22a independently of a switching position of the switches 30a, 32a. In this case the electrically conductive connection between the second inverter 20a and the first output connection 22a is formed by the second bridging element 36a.

In the operating state the configuration unit 12a is intended to operate the inverters 18a, 20a in parallel to a group of the heating elements 26a, 28a. For example, the configuration unit 12a could switch a switching position of the switch 30a from the “normally closed” contact to the “normally opened” contact, as a result of which the inverters 18a, 20a are operated in parallel to the heating elements 28a. Alternatively the configuration unit 12a could switch a switching position of the second switch 32a from the “normally closed” contact to the “normally opened” contact, as a result of which the inverters 18a, 20a are operated in parallel to the heating elements 26a. The operating state, in which the inverters 18a, 20a are operated jointly in parallel to a group of the heating elements 26a, 28a, is referred to as a boost mode. In a further operating mode it is conceivable for the first group of the heating elements 26a to be operated on the second inverter 20a. Likewise, in the further operating mode it is possible to operate the second group of the heating elements 28a on the first inverter 18a.

The hob apparatus 10a comprises a switching unit 38a, which is switched between the configuration unit 12a and the heating elements 26a, 28a. The switching unit 38a has two input connections 56a, 58a. A first input connection 56a of the input connections 56a, 58a of the switching unit 38a is connected to the second output connection 24a of the configuration unit 12a. A second input connection 58a of the input connections 56a, 58a of the switching unit 38a is connected to the first output connection 22a of the configuration unit 12a. The switching unit 38a has a plurality of output connections 60a. A number of output connections 60a of the switching unit 38a is substantially identical to a number of heating elements 26a, 28a.

The switching unit 38a has a plurality of further switches 40a, 42a, which are each intended to connect one of the heating elements 26a, 28a individually to the configuration unit 12a. The further switches 40a, 42a are split into two groups. In this case a first group has the further switches 40a which are associated with the first group of the heating elements 26a. In each case a further switch 40a of the first group is connected to a heating element 26a of the first group and is intended to connect the respective heating element 26a individually to the configuration unit 12a. A second group has the further switches 42a which are associated with the second group of the heating elements 28a. In each case a further switch 42a of the second group is connected to a heating element 28a of the second group and is intended to connect the respective heating element 28a individually to the configuration unit 12a.

The hob apparatus 10a comprises a plurality of resonance capacitors 62a. Each resonance capacitor 62a is associated with one of the heating elements 26a, 28a. A number of resonance capacitors 62a is substantially identical to a number of heating elements 26a, 28a. Alternatively it is conceivable for the hob apparatus to have exactly one resonance capacitor per group of heating elements, wherein the hob apparatus in the present exemplary embodiment could in particular have two resonance capacitors which could each be associated with a group of heating elements. In the present exemplary embodiment each resonance capacitor 62a has two capacitors. Alternatively embodiments having a different number of capacitors are conceivable.

FIGS. 5 to 13 show further exemplary embodiments of the invention. The following descriptions are substantially limited to the differences between the exemplary embodiments, wherein in respect of components, features and functions which remain identical reference can be made to the description of the exemplary embodiments in FIGS. 1 to 4. To distinguish the exemplary embodiments the letter a in the reference characters of the exemplary embodiments in FIGS. 1 to 4 is replaced by the letter b in the reference characters of the exemplary embodiments in FIGS. 5 to 13. In respect of identically designated components, in particular in reference to components having identical reference characters, reference can in principle also be made to the drawings and/or the description of the exemplary embodiments in FIGS. 1 to 4.

FIG. 5 shows a hob apparatus 10b, which is designed as an induction hob apparatus, of a hob which is designed as an induction hob. The hob apparatus 10b comprises a configuration unit 12b which has two input connections 14b, 16b. The input connections 14b, 16b are each intended to form a connection to an inverter 18b, 20b of the hob apparatus 10b. Furthermore the configuration unit 12b has two output connections 22b, 24b. A first output connection 22b of the output connections 22b, 24b is intended to form a connection to heating elements 26b of the hob apparatus 10b. A second output connection 22b of the output connections 22b, 24b is intended to form a connection to heating elements 28b of the hob apparatus 10b.

A switch 30b of the hob apparatus 10b is connected to a first input connection 14b of the input connections 14b, 16b and the first output connection 22b. A “normally opened” contact of the switch 30a is connected to the first output connection 22b. The switch 30b is additionally connected to the second output connection 24b. A “normally closed” contact of the switch 30b is connected to the second output connection 22b. For example, the configuration unit could have exactly the one switch (cf. FIG. 6), wherein further switches, in particular a second switch, could be dispensed with. Preferably however the configuration unit 12b has a second switch 32b (cf. FIG. 5), which is connected to the second input connection 16b and the second output connection 24b. A “normally opened” contact of the second switch 32b is connected to the second output connection 24b. The second switch 32b is additionally connected to the first output connection 22b. A “normally closed” contact of the second switch 32a is connected to the first output connection 22b. As shown in FIG. 7, the configuration unit could have exactly the one second switch, wherein the switch could be dispensed with.

The configuration unit 12b has a bridging element 34b, which connects the first input connection 14b and the second output connection 24b to one another independently of a switching position of the switches 30b, 32b. In this case the bridging element 34b bridges the “normally closed” contact of the switch 30b. The configuration unit 12b has a second bridging element 36b, which connects the second input connection 16b and the first output connection 22b to one another independently of a switching position of the switches 30b, 32b. The second bridging element 34b bridges the “normally closed” contact of the second switch 32b.

A switching unit 38b of the hob apparatus 10b is switched between the configuration unit 12b and the heating elements 26b, 28b and has a plurality of further switches 40b, 42b. The respective further switches 40b, 42b are intended to connect one of the heating elements 26b, 28b individually to the configuration unit 12b. The further switches 40b, 42b are designed as changeover switches (cf. FIG. 5). The further switches 30b, 32b are designed as relays. Each further switch 40b, 42b has a “changeover” contact, a “normally opened” contact and a “normally closed” contact. In the present exemplary embodiment the “changeover” contact of the further switches 40b, 42b is in each case disposed on a side of the further switches 40b, 42b facing away from the configuration unit 12b. Each “changeover” contact of the further switches 40b, 42b is connected to one of the heating elements 26b, 28b. Each further switch 40b, 42b is connected to the configuration unit 12b via the “normally opened” contact. Alternatively it is conceivable for each further switch 40b, 42b to be connected to the configuration unit 12b via the “normally closed” contact—as shown for example in FIG. 8.

In further alternative arrangements of the further switches 40b, 42b it is conceivable for the “changeover” contact of the further switches 40b, 42b to be connected to the configuration unit 12b (cf. FIGS. 9 and 10). In this case each further switch 40b, 42b could be connected to one of the heating elements 26b, 28b via the “normally opened” contact (cf. FIG. 9). As illustrated in FIG. 10, each further switch 40b, 42b could however also be connected to one of the heating elements 26b, 28b via the “normally closed” contact.

Alternatively to an embodiment of the further switches 40b, 42b as changeover switches it is conceivable for the further switches 40b, 42b to be designed as on-off switches (cf. FIGS. 11 and 12). In this case each further switch 40b, 42b could have a “changeover” contact and a “normally opened” contact. Likewise conceivable is for each further switch 40b, 42b to have a “changeover” contact and a “normally closed” contact (not illustrated). As shown in FIG. 11, each further switch 40b, 42b could be connected to the configuration unit 12b via the “normally opened” contact. In this case each further switch 40b, 42b would be connected to one of the heating elements 26b, 28b via the “changeover” contact. Alternatively to this, each further switch 40b, 42b could be connected to one of the heating elements 26b, 28b via the “normally opened” contact (cf. FIG. 12). In this case each further switch 40b, 42b could be connected to the configuration unit 12b via the “changeover” contact.

It is furthermore conceivable for a switching position of the configuration unit 12b and a switching position of the switching unit 38b to be coupled to one another. This can be explained by using FIG. 5 as an example. For example, a switching position of the “normally closed” contacts of the further switches 40a, 42a could be coupled to a switching position of the “normally opened” contacts of the switches 30b, 32b of the configuration unit 12b. In this case, in the event that the “changeover” contact and the “normally opened” contact of the switch 30a are connected to one another, for each further switch 40a of the first group the “changeover” contact is connected to the “normally closed” contact. In the present exemplary embodiment the configuration unit 12b and the switching unit 38b are however designed independently of one another. In particular switching positions of the configuration unit 12b and switching positions of the switching unit 38b can be set independently of one another.

By means of the switches 30b, 32b the configuration unit 12b is intended in a operating state to operate the inverters 18b, 20b in parallel to a group of the heating elements 26b, 28b. In this case it is conceivable for the configuration unit 12b in the operating mode to operate the inverters 18b, 20b in parallel to exactly one heating element 26b, 28b of a group of the heating elements 26b, 28b. Alternatively the configuration unit 12b in the operating mode could operate the inverters 18b, 20b in parallel to a plurality of and/or all heating elements 26b, 28b of a group of the heating elements 26b, 28b. Furthermore it is conceivable for the configuration unit 12b in a further operating mode to operate each of the inverters 18b, 20b at one of the group of heating elements 26b, 28b, wherein a majority and advantageously all heating elements 26b, 28b are in operation jointly.

The hob apparatus 10b comprises a plurality of resonance capacitors 62b. Each resonance capacitor 62b has capacitors. Alternatively, embodiments having a different number of capacitors are conceivable. Each resonance capacitor 62b is associated with one of the heating elements 26b, 28b, wherein a number of resonance capacitors 62b is substantially identical to a number of heating elements 26b, 28b. As illustrated in FIG. 13, it is alternatively conceivable for the hob apparatus 10b to have exactly one resonance capacitor 62b per group of heating elements 26b, 28b. In this case the hob apparatus 10b could in particular have two resonance capacitors 62b, which could each be associated with a group of heating elements 26b, 28b.

Alternatively to an embodiment having two inverters, embodiments having another number of inverters are possible, in particular having more than two inverters, which could each be connected to the rectifier. In this case a number of switches of the configuration unit would be appropriately adjusted, wherein in particular an algorithm could be used for calculating a minimum required number of switches.

### REFERENCE CHARACTERS

10 Hob apparatus

12 Configuration unit

14 First input connection

16 Second input connection

18 Inverter

20 Inverter

22 First output connection

24 Second output connection

26 Heating element

28 Heating element

30 Switch

32 Switch

34 Bridging element

36 Bridging element

38 Switching unit

40 Further switch

42 Further switch

44 Hob

46 Hob plate

48 Operating unit

50 Control unit

52 Rectifier

54 Phase

56 First input connection

58 Second input connection

60 Output connection

62 Resonance capacitor

1-10. (canceled)

11. A hob apparatus, comprising at least one configuration unit including at least two input connections adapted for connection to at least two inverters in one-to-one correspondence, at least two output connections adapted for connection to at least two heating elements in one-to-one correspondence, and at least one switch operably connected to a first one of the at least two input connections and operably connected to at least a first one of the at least two output connections, said at least one configuration unit being configured to operate the at least two inverters in at least one operating state in parallel to at least one of the at least two heating elements, said at least one configuration unit including at least one bridging element configured to connect the first one of the at least two input connections and a second one of the at least two output connections to one another independently of a switching position of the at least one switch.

12. The hob apparatus of claim 11, constructed in the form of an induction hob.

13. The hob apparatus of claim 11, wherein the at least one switch is connected to the second one of the at least two output connections.

14. The hob apparatus of claim 11, wherein the at least one bridging element is configured to bridge a “normally closed” contact of the at least one switch.

15. The hob apparatus of claim 11, wherein the at least one configuration unit includes at least one second switch which is connected to a second one of the at least two input connections and at least to the second one of the at least two output connections.

16. The hob apparatus of claim 15, wherein the at least one second switch is additionally connected to the first one of the at least two output connections.

17. The hob apparatus of claim 11, wherein the at least one configuration unit includes at least one second bridging element which is configured to connect a second one of the at least two input connections and the first one of the at least two output connections to one another.

18. The hob apparatus of claim 17, wherein the at least one configuration unit includes at least one second switch which is connected to a second one of the at least two input connections and at least to the second one of the at least two output connections, said at least one second bridging element being configured to bridge a “normally closed” contact of the at least one second switch.

19. The hob apparatus of claim 11, further comprising a switching unit switched between the at least one configuration unit and the at least two heating elements.

20. The hob apparatus of claim 19, wherein the switching unit includes at least two further switches, each of the least two further switches being configured to connect one of the at least two heating elements individually to the configuration unit.

21. A hob, comprising at least one hob apparatus which includes at least one configuration unit including at least two input connections adapted for connection to at least two inverters in one-to-one correspondence, at least two output connections adapted for connection to at least two heating elements in one-to-one correspondence, and at least one switch operably connected to a first one of the at least two input connections and operably connected to at least a first one of the at least two output connections, said at least one configuration unit being configured to operate the at least two inverters in at least one operating state in parallel to at least one of the at least two heating elements, said at least one configuration unit including at least one bridging element configured to connect the first one of the at least two input connections and a second one of the at least two output connections to one another independently of a switching position of the at least one switch.

22. The hob of claim 21, wherein the hob apparatus is constructed in the form of an induction hob.

23. The hob of claim 21, wherein the at least one switch is connected to the second one of the at least two output connections.

24. The hob of claim 21, wherein the at least one bridging element is configured to bridge a “normally closed” contact of the at least one switch.

25. The hob of claim 21, wherein the at least one configuration unit includes at least one second switch which is connected to a second one of the at least two input connections and at least to the second one of the at least two output connections.

26. The hob of claim 25, wherein the at least one second switch is additionally connected to the first one of the at least two output connections.

27. The hob of claim 21, wherein the at least one configuration unit includes at least one second bridging element which is configured to connect a second one of the at least two input connections and the first one of the at least two output connections to one another.

28. The hob of claim 27, wherein the at least one configuration unit includes at least one second switch which is connected to a second one of the at least two input connections and at least to the second one of the at least two output connections, said at least one second bridging element being configured to bridge a “normally closed” contact of the at least one second switch.

29. The hob of claim 21, wherein the hob apparatus includes a switching unit switched between the at least one configuration unit and the at least two heating elements.

30. The hob of claim 29, wherein the switching unit includes at least two further switches, each of the least two further switches being configured to connect one of the at least two heating elements individually to the configuration unit.
